(19) United States
(12) Patent Application Publication
(10) Pub. No.: US 2001/0046711 A1
(43) Pub. Date: Nov. 29, 2001

(54) Method for the determination of an acid or a base in a non-aqueous liquid

(76) Inventors: Phan van Pham, Angleton, TX (US); Sofia Galanis Hohnholt, Brookline, MA (US); Raymond Alfonsas Plepys, Lake Jackson, TX (US); Purnendu K. Dasgupta, Lubbock, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/817,686

(22) Filed: Mar. 26, 2001

Related U.S. Application Data
(60) Provisional application No. 60/193,013, filed on Mar. 29, 2000.

(51) Int. Cl. G01N 31/22

(52) U.S. Cl. 436/100

(57) ABSTRACT

A chemical analysis method for the determination of a base (or an acid) in a nonaqueous liquid (such as a polyol) which method can be automated and placed on-line in a chemical production facility. The instant invention includes two steps. The first step is to mix an acid-base indicator (for example, bromocresol green) with the non-aqueous liquid to produce a colored reaction product between the base or acid and the acid-base indicator. The second step is to determine the intensity of the color of the colored product.

### CROSS REFERENCE TO RELATED APPLICATION

This application claims the benefit of U.S. Provisional Application No. 60/193,013, filed Mar. 29, 2000.

### BACKGROUND OF THE INVENTION

The instant invention is in the field of chemical analysis and more particularly the instant invention is in the field of calorimetric analysis using acid-base indicators.

Flow Injection Analysis (FIA) is an important technique in the field of chemical analysis, Ruzicka and Hansen, Flow Injection Analysis, 1981. FIA methods are known for the determination of acids or bases in liquid samples, Rhee and Dasgupta, Mikrochimica Acta 1985, III, 49-64 and 107-122, herein fully incorporated by reference.

Polyols are used, for example, in the manufacture of polyurethane polymer. The polyol is reacted with, for example, toluene-2,4-diisocyanate to produce the polyurethane polymer, Tullo, Chem Eng. News, 1999, 77(47), 14.

The polyol may contain traces of acid or base. Traces of acid or base in the polyol can effect the polymerization characteristics (such as the polymerization rate) depending on the concentration of the acid or base. Therefore, it is important to determine the concentration of acid or base in the polyol when producing the polyurethane. The industry standard method for determining acid or base in polyol since 1960 (Scholten et al., J. Chem. Eng. Data, 1960, 6, 395) is manual titrimetry. Recently (1999), the manual titrimitry method for the determination of traces of base in polyols has been standardized as ASTM standard method D 6437-99.

The manual titrimetry method works well but it is relatively slow, labor intensive and expensive. It would be an advance in the art of determining acid or base in a polyol if an automated method were developed, especially if such an automated method could be placed on-line in a chemical production facility.

FIA has not been applied to the determination of acids or bases in polyol samples despite the fact that FIA can be automated and placed on-line in a chemical production facility.

### SUMMARY OF THE INVENTION

The instant invention is a solution to the above-mentioned problems. The instant invention is a chemical analysis method for the determination of a base (or an acid) in a non-aqueous liquid (such as a polyol) that can be automated and placed on-line in a chemical production facility.

In one embodiment the instant invention is a chemical analysis method for the determination of a base in a non-aqueous liquid (such as a polyol) comprising two steps. The first step is to disperse an acid-base indicator with the non-aqueous liquid to produce a colored product. The second step is to determine the intensity of the color of the colored product.

In another embodiment, the instant invention is a chemical analysis method for the determination of an acid in a non-aqueous liquid (such as a polyol) comprising two steps. The first step is to disperse an acid-base indicator with the non-aqueous liquid to produce a colored product. The second step is to determine the intensity of the color of the colored product.

In yet another embodiment, the instant invention is a chemical analysis method for the determination of a base in a non-aqueous liquid (such as a polyol) comprising two steps. The first step is to disperse an acid-base indicator with the non-aqueous liquid to produce a concentration dispersion of the acid-base indicator in the non-aqueous liquid to produce a concentration dispersion of a colored product in the non-aqueous liquid. The second step is to determine the intensity of the color of the concentration dispersion of the colored product in the non-aqueous liquid.

In still yet another embodiment the instant invention is a chemical analysis method for the determination of an acid in a non-aqueous liquid (such as a polyol) comprising two steps. The first step is to disperse an acid-base indicator with the non-aqueous liquid to produce a concentration dispersion of the acid-base indicator in the non-aqueous liquid to produce a concentration dispersion of a colored product in the polyol. The second step is to determine the intensity of the color of the concentration dispersion of the colored product in the non-aqueous liquid.

### BRIEF DESCRIPTION OF THE DRAWINGS

FIG. 1 is a schematic drawing of an apparatus that may be used to carry out the method of the instant invention;

FIG. 2 is a plot of computed optical absorbance at 605 nanometers wavelength v. base concentration (for an aqueous medium);

FIG. 3 is a plot of optical absorbance at 605 and 436 nanometers wavelength v. time;

FIG. 4 is a plot of optical absorbance at 605 nanometers v. time for various base concentrations of Example 1;

FIG. 5 is a plot of optical absorbance at 605 nanometers v. base concentration of Example 1;

FIG. 6 is a plot of optical absorbance at 605 and 436 nanometers v. base concentration of Example 2;

FIG. 7 is a plot of optical absorbance at 605 nanometers v. base concentration in polyol samples having different water levels of Example 3; and

FIG. 8 is a block diagram showing the analyzer connected to a chemical process.

### DETAILED DESCRIPTION OF THE INVENTION

A “non-aqueous liquid” is defined herein as a liquid containing less than one percent water by weight. Examples of non-aqueous liquids include liquids made by reacting, for example, ethylene oxide and or propylene oxide and or 1,2-butylene oxide or mixtures thereof with methanol, ethanol, propanol, butanol, ethylene glycol, propylene glycol, glycerin, trimethylol propane, pentaerythritol, sorbitol and glucose or mixtures thereof.

Specific examples of non-aqueous liquids include polyether polyols (such as VORANOL BRAND polyether polyols from The Dow Chemical Company), polyglycols (such as DOWANOL BRAND polyglycols from The Dow Chemical Company) and polyester polyols. In general, the equivalent weight of such liquids (molecular weight per OH group) ranges from about 75 to about 4,000. Examples of a base that may be present in a non-aqueous liquid are potassium hydroxide, sodium hydroxide and cesium hydroxide. An example of an acid that may be present in a non-aqueous liquid is sulfuric acid and toluene sulfonic acid.

Chemicals and Reagents

Polyol samples are supplied in 1 gal. capacity hermetically sealed drums (Voranol® brand polyether polyol from The Dow Chemical Company). The KOH content of these samples is determined by potentiometric titrimetry in aliquots drawn in parallel. Most of the work described in this disclosure is conducted with polyol samples containing 1.5 ppm (polyol A) and 119 ppm (polyol B) KOH; intermediate concentrations were generated from these. A neutral polyol sample (passed through a mixed bed ion exchanger) is also used in some experiments. Care is taken to avoid exposure of the polyol samples to atmospheric CO₂. The container cap is modified to provide for a sample exit line (that goes to the bottom of the container) and an aperture to provide for a 2 psi Nitrogen blanket (filtered through a soda-lime cartridge, SLT). Both lines are metallic to eliminate permeative CO₂ intrusion. Initially, the container is opened and the operating cap installed in a glove bag under nitrogen.

Bromothymol blue (BTB), bromocresol green (BCG), and bromophenol blue (BPB) acid-base indicators are obtained from ACROS (all in the free acid form). ACS grade 2-propanol (2-PrOH) is used as the solvent. For the determination of 1.5 to 20 ppm KOH, a solution of 6.997 g of BCG per L of 2-PrOH (nominally 10 MM) is used. For the determination of 20-120 ppm KOH, the indicator solution contains 10.508 g BCG (nominally 15 mM) and 50 mL 1.0 M aqueous HCl per L of 2-PrOH. Indicator solutions are kept in a dark container R provided with a liquid exit tube and also provided with a soda-lime filtered 2 psi nitrogen blanket.

For exact flow ratio measurements (vide infra), polyol B is doped with Magdala Red (Pfaltz and Bauer, Stamford, Conn.) an intensely fluorescent base-insensitive dye ((λ_{ex, max} 540 nm, λ_{em, max} 570 nm). A dye concentration of 0.41 mg per L polyol is used.

Instrumental Arrangement

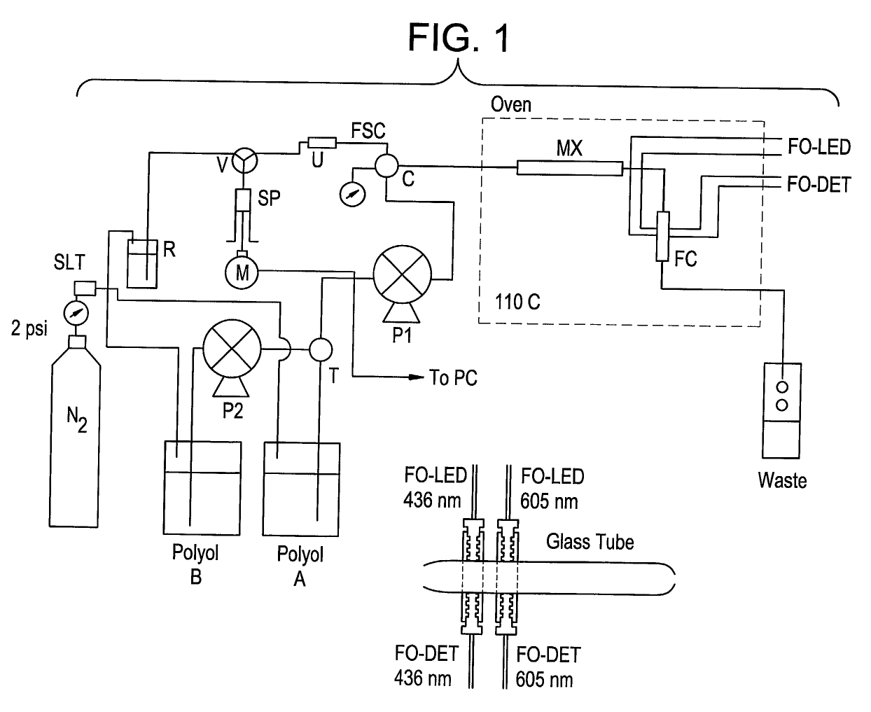

The experimental configuration is shown schematically in FIG. 1. Peristaltic pumps were used for pumping. Pump 1 (P1, Minipuls 2, Gilson Medical Electronics) has a fixed flow rate of 1 mL/min. The input to it is partly supplied by pump 2 (P2, Model XV, Alitea USA) pumping polyol B (flow rate≦1 mL/min) and the balance, consisting of polyol A, is drawn through a ¼-28 threaded tee fitting T. The KOH content of the polyol ultimately delivered by P1 is thus increased or decreased by increasing or decreasing the flow rate of P2. PharMed pump tubing (Norton Performance Products) is used in both peristaltic pumps (internal-external diameters: 1/16″-3/16″, 1/32″-5/32″ for P1 and P2, respectively). For all experiments, the exact ratio in which polyols A and B are blended is determined by fluorescence measurements of the mixture produced by P1 (either at the exit of P1 or more commonly at the system exit) from a knowledge of the fluorescence intensity of sample B itself, and a calibration curve relating the fluorescence intensity of sample B when diluted in a known manner by undoped polyol. Fluorescence intensities are measured with a spectrofluorometer (RF 540, Shimadzu Scientific).

The P1 output proceeds to a ¼-28 threaded cross fitting C. One port of C is connected to a pressure transducer to read the system pressure. The third port of C is connected to the indicator delivery pump SP (model 50300 syringe pump equipped with a 48000 step stepper motor M, an integral automated aspirate/dispense 3-way valve V and a 500 μL capacity glass syringe, Kloehn Inc., Las Vegas, Nev.) via an union fitting U connecting the 1.5 mm o.d.×0.5 mm i.d. PEEK tubing from the syringe pump to a fused silica capillary FSC (100 μm in internal diameter, 6 cm long). The small aperture of the capillary minimizes the diffusive bleeding of the indicator into the flowing polyol stream.

The operation of SP is controlled by an IBM ThinkPad 560 laptop PC through its RS-232 port using vendor-supplied software. Once programmed, the pump protocol resides in the pump memory, leaving the PC free for other tasks. All other interconnecting tubing in the system is polytetrafluoroethylene (PTFE).

The output port of C is connected to a 0.027″ i.d., 0.069″ o.d. PTFE tube that proceeds to a heated enclosure maintained at 110° C. (to simulate process conditions). A gas chromatograph oven (Shimadzu GC-8A) is used for the purpose. The polyol stream then proceeds through a stainless steel passive mixer MX consisting of intertwined helices (Koflo®, P-04669-52, 6″ long, 3/16″ OD, 0.13″ ID, 21 elements, Cole Parmer Inc.).

The mixer effluent proceeds through the flow-through optical absorbance detection arrangement (FC) to waste. The conduit volume from C to FC is 1.1 mL. Details of the detector cell arrangement are shown in the inset of FIG. 1. The optical cell is a square cross section glass tube of 2×2 mm internal dimensions. The glass tube termini (especially the inlet) are flame treated to provide a circular cross section. This reduces dispersion and improves reproducibility. The glass tube passes through holes drilled for the purpose into each of two ¼-28 threaded male-male unions made from PEEK; each constitutes a separate detection cell. The glass tube itself is cormected to entry and exit tubing via ¼-28 threaded unions. O-rings are utilized to assure a positive seal.

Since the performance of either LEDs or photodiodes degrade considerably with increasing temperature, optical communication with each cell was carried out with a pair of 1 mm core high numerical aperture Teflon clad fused silica optical fibers FO, one each across the cross section of the glass tube on opposite sides.

A 605 nm LED and a 436 nm LED were put in LED holders (Global FIA, Gig Harbor, Wash.) that allow for the connection of optical fibers to the LED. A short length of optical fiber connects the bottom of each LED to a silicon photodiode located on the detector electronics board, this photodiode serves as the reference detector. The fiber connecting the emitting face of each LED proceeds to the respective cell in the oven and the return fibers from each of the two cells are each connected to a second silicon photodiode. The light input to this photodiode is filtered with colored plastic filters (#809 and #859 for the 605 nm and the 436 nm LEDs, respectively, Edmund Scientific, Barrington, N.J.) to nimize cross talk between the two detection cells. The reference and detector diode photocurrents from each detector are fed to a log-ratio amplifier (LRA) each. This directly provides absorbance output (1V/AU) with significant offset capabilities. The specific LRA devices used were of older design, based on hybrid monolithic integrated circuits (757N, Analog Devices) that are considerably more noisy than devices presently available.

At the beginning of each day, the system is allowed to equilibrate for 20 min prior to indicator injection. A minimum of 6 injections, 6 minutes apart, are made at each P2 setting; 10 min was allowed for equilibration with every change of P2 setting.

Data Acquisition and Processing

The detector outputs are sent to a PCMCIA type data acquisition card (PCMDAS16D/12, Computerboards, Middleboro, Mass.) and collected and displayed by vendor-supplied software (DAS Wizard), that runs as a subprogram in Microsoft® Excel. The same PC used to program the syringe pump is used for data acquisition and processing.

Water Saturation

The water content of a polyol sample is increased, when desired, by pumping the sample through a water saturation device. Nafion® tubing (wet dimensions ˜0.8 mm i.d., 1.2 mm o.d., 330 mm active length) is housed in a tubular PTFE jacket (4.2 mm i.d., ˜330 mm long) with a tee fitting at each end. Connections to the Nafion tube are made with PTFE tubes inserted therein, with Kevlar® thread ties atop. These tubes exited through the straight arms of each tee and provided the means of maintaining a flow of water through the Nafion tube, pumped by an independent pump. The water flow rate is not critical. The polyol sample flows through the Teflon jacket, around the Naflon brand ion exchange tube. The Nafion brand ion exchange tube is converted to the potassium ion form prior to use. When used, the device is inserted between the output of P1 and cross C. Polyol samples are collected before and after the water saturation device. The water content of these samples is determined by Karl Fisher titration.

System Problems

At first, it may seem that an acid-base indicator-based method relies on quantitative hydroxide ion induced conversion of the yellow indicator monoaanion to the blue indicator dianion. With the indicators studied, that is what would be expected in water. To practice such a scheme, it is necessary to have large indicator concentrations to avoid an indicator-limited situation. Further, even in the absence of a base, the blank response from indicator injection may be significant due to indicator self-ionization. Also, it can be preferable to avoid waste generation by directing the analytical system waste back to the process stream as shown in FIG. 8. This is practical especially if the total amount of indicator introduced remains very small.

The pKₐ values for BTB, BCG and BPB in water are respectively 7.10, 4.68, and 3.85. It is interesting to look at the predicted response behavior if the medium was water and the choice of indicators extended to much weaker acids. We assume an injected Hin concentration of 0.01 M, a dispersion factor of 30 (such that at the peak maximum the total indicator concentration [In]T is 3.33×10⁻⁴ M), a molar absorptivity for In⁻ of 4×10⁻⁴, and an optical path length of 2 mm. The response behavior is solved by iteratively solving the charge balance equation:

[H⁺]+[K⁺]−K_{w}/[H⁺]−[In⁻]=0 (1)

where

[In⁻]=[In]_{T}K_{In}/([H⁺]+K_{In}) (2)

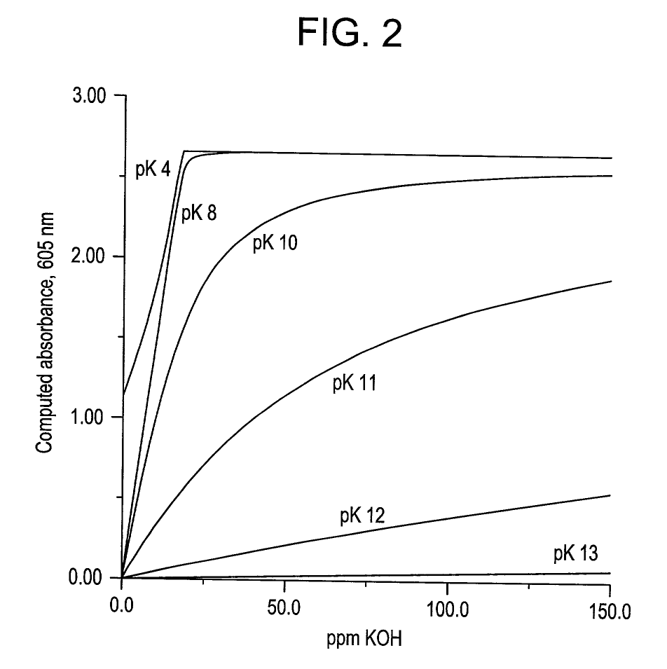

The absorbance due to In⁻ is then computed from Beer's law. The results are shown in FIG. 2. It is obvious that indicators that are relatively weak are attractive, although too weak an indicator may lead to poor sensitivity. A compromise situation is obtained with pK_{In} 12, there is good linear behavior and decent sensitivity. The lower pK_{In} indicators tend to reach saturation too rapidly. Note that the indicator concentration is <5% of the maximum KOH concentration used in these simulations. Preferred acid-base indicators have an aqueous pKa between 2 and 10 for base determination and an aqueous pKb between 2 and 12 for acid determination. Examples of preferred indicators are: methyl orange, ethyl orange, methyl red, ethyl red, alizarin red, bromocresyl purple, bromothymol blue and phenosulphothalein.

In a polyol medium, the solvent autoionization constant, as well as the indicator dissociation constants, are bound to be much lower than in water (although the relative order of ionization among the indicators should be consistent). BTB, BCG and BPB have similar spectral properties. The same detection system can be used to rapidly test which (if any) of these indicators will provide for a feasible determination method. The availability of LEDs emitting at wavelengths suitable for monitoring the blue indicator dianion absorption and their ready adaptability to construct fiber optic based absorbance detectors were also attractive.

Mixing and Pumping Problems

Laboratory experimentation with polyol systems under simulated process conditions raise some significant problems. It is troublesome to maintain a large polyol storage container at an elevated temperature; also, most pumps cannot be housed at 110° C. On the other hand, at room temperature, the viscosity of the polyol is 50 cP, making it extremely difficult for a reciprocating type high pressure liquid chromatographic pump to refill properly. Refilling with a viscous liquid is also a major problem with any syringe type pump.

Achieving mixing homogeneity and the choice of a pumping method are interrelated issues. Due to the high viscosity of the medium, the mixing element is necessary for efficient mixing and for reproducible dispersion of the injected indicator. Initially, a modified serpentine-II style mixer (Shahwan, LC-GC Mag., 1988, 6, 158) (0.69 mm i.d., 1.8 mm o.d. PTFE tube, 1 m long, woven on a grid spacing of 2.0 mm) in series with a packed bed mixer (4×50 mm, filled with 1.0 mm diameter glass beads with glass wool plugs as retainer) is used as a mixer. Although none of the mixers could individually achieve the desired degree of mixing with ease, they were adequate in series. However, the pressure drop was significant and gear pumps were preferred to pump the polyol. A large process style gear pump equipped with a special low flow head, operating at 2% of its maximum flow rate is used to achieve a stable flow rate of 1 mL/min and is used for generating much of the initial data. However, it is difficult to use two such pumps to create polyol blends of varying KOH content due to the difficulty of reducing flow rates further.

Moreover, even when such samples are created by manual off-line blending, each sample change at the pump input requires extended times for a stable output composition due to the poorly swept and significant pump head volume.

A Search for alternatives led us to the helical mixer. This allowed adequate mixing of the stream at the desired flow rates used in the system and with negligible pressure drop (<5 psi at 1 mL/min) that allowed in turn the use of peristaltic pumps. Compared to poly(vinyl chloride) type pump tubing, Pharmed® tubing exhibited longer lifetime with minimal changes in flow rate for use with the polyol. We opted, nevertheless, to measure each blending ratio by fluorescent dye doping rather than relying strictly on the pump settings.

Detection

Monitoring at a single wavelength that corresponds to the absorption of the blue indicator dianion is adequate for the determination itself. It is simple, however, to implement measurement at other wavelengths. Multiwavelength measurement would be of considerable benefit in diagnosing instrument malfunction such as fouling of optical windows, proper injection of the indicator etc. Given the current cost and ease of implementation of PC card based photodiode arrays, the optimum choice for an on-line process instrument may well involve such a detector, in conjunction with a stable broadband light source (e.g., a flash lamp or a white LED). Monitoring at a second wavelength can provide the following information: (a) an indication of cell fouling when both, rather than just one detector, shows decreased light throughput (this may not, however, represent a particular problem with polyols—in extensive experiments with such systems we have not experienced an occurrence of cell fouling); and (b) positive evidence that the indicator has been injected and in the right amount.

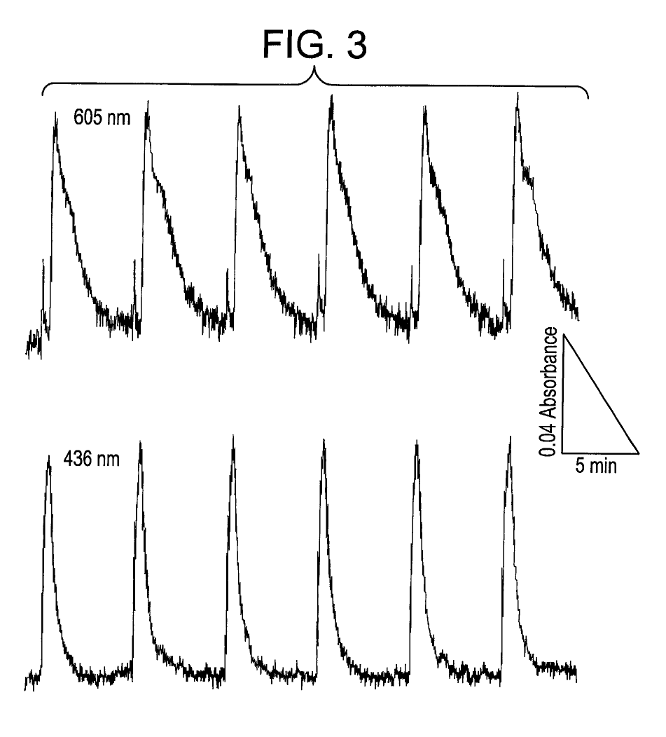

The choice of the two individual wavelengths is, of course, important. BTB, BPB and BCG have similar (albeit not identical) spectra. The pH-dependent spectra of BCG exhibit a broad absorption maximum around 615 nm for the blue dianion, an absorption maximum around 440 nm for the yellow monoanion, and an isosbestic wavelength (λᵢ) around 510 nm (Vithanage and Dasgupta, Anal. Chem., 1986, 58, 326). An orange LED emitting at 605 nm serves adequately to monitor the dianion. The choice of the second wavelength is made complicated by the fact that blue form of the indicator also absorbs in the yellow, this absorption having a maximum at 400 nm. Monitoring at XI will be the most straightforward. When the same amount of indicator is injected (and the hydrodynamic properties, including flow rate that controls dispersion remains constant), this signal remains constant, irrespective of the concentration of KOH. However, at the time we undertook this study, an LED at this wavelength was unavailable (more recently, green superluminescent GaN LEDs emitting in this desired region have become available). We chose instead a SiC based emitter with a measured center wavelength at 436 mn. With a relatively wide half bandwidth of ˜65 nm, the response from this source is a combination of responses due to the monoanion and dianion forms of the dye. Thus, unlike the 605 nm detector, with this detector, indicator injection produces a response regardless of the base content of the polyol. While monitoring the constancy of indicator injection is less straightforward at 436 nm than at monitoring at λᵢ, for any given value of the 605 nm detector response, the value for the 436 nm detector response is unique at a constant amount of indicator injected and can thus be used for diagnostic purposes. The S/N is slightly worse for the 436 nm vs. the 605 nm detector at equivalent absorbances. The former is therefore placed to be the first in the series so as to be subject to less dispersion. There is 1.0 cm between the two detectors but with a relatively large bore square tube, this led to a surprisingly large amount of dispersion in the second detector as seen in FIG. 3.

While an inspection of these data will indicate that injections can be made in this system every 4 min without the second detector being affected by the previous injection, it is of course possible to use the same cell for multiwavelength detection and thus to make injections at more frequent intervals if desired.

It should be understood that the “color” of the colored product of the reaction between the base (or acid) to be determined in the non-aqueous liquid and the acid-base indicator may be detectable anywhere in the electromagnetic spectrum and is not limited to the visible region of the electromagnetic spectrum.

Indicator Problems

Using the experimental system described, the response to indicator injections of different compositions is studied for polyol streams containing 0-20 ppm KOH, the lowest nonzero value being 1.5 ppm. Water has limited solubility in the polyol; aqueous indicator solutions are unsuitable for injection into polyol streams. Ten microliters of 2 mM solutions of each of the three indicators were initially tried and resulted in problems. Using a 10 mM solution of BPB (10 L injected at 8.33 μL/s), the most easily ionized of the three, as the indicator, very low levels of KOH could be easily detected but indicator saturation occurred by the 10 ppm KOH level. With, BTB, the least acidic of the three, KOH concentrations below 15 ppm could not be measured. However, BCG allowed for a usable measurement range of 1.5-20 ppm KOH.

### EXAMPLE 1

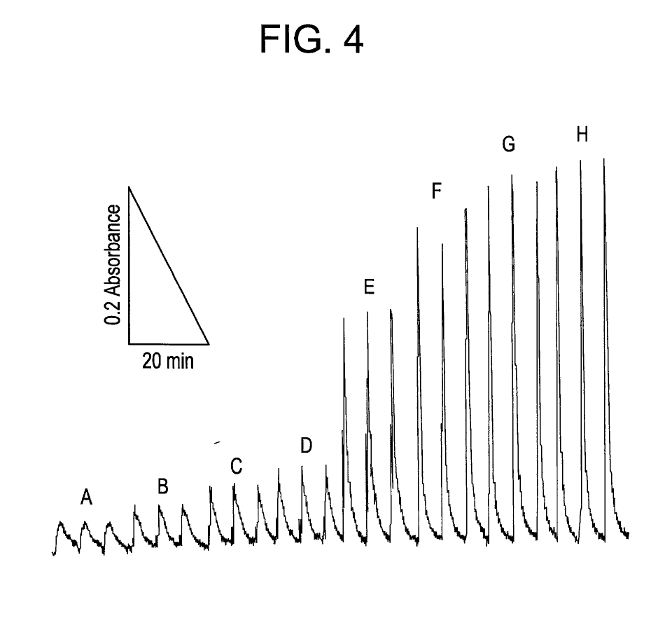

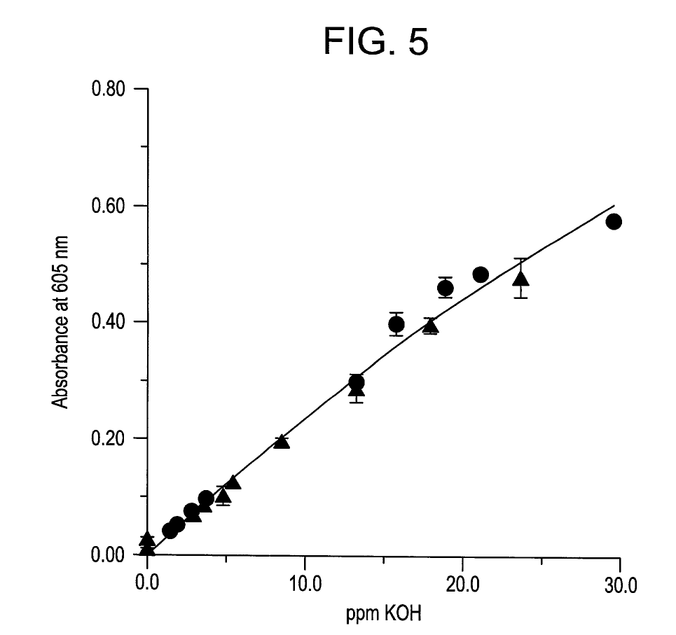

FIG. 4 shows typical performance at 605 nm for 1.5 to 20 ppm KOH. FIG. 5 shows the data from two disparate runs (with ±1 sd error bars on each measurement, n=6) taken 2.5 months apart.

Theoretical Discussion

For a theoretical prediction of the above response, we invoke here the Franklin-Marshall solvent system theory of acids and bases and assume that both the proton and hydroxide are solvated by polyol (POH) to produce the characteristic cation (POH₂⁺) and anion (PO⁻) of the solvent. The charge balance equation for a system containing the acid form of the indicator HIn, KOH and the polyol can be written:

[POH₂⁺]+[K⁺]=[PO⁻]+[In⁻] (3)

Where it is understood that K⁺ and In⁻ are likely also solvated by polyol. It is also reasonable to assume that [POH₂⁺] is going to be substantially smaller than [K⁺] at KOH concentrations of interest to us and can therefore be neglected. The proton transfer reaction with the indicator itself can be written:

HIn+PO⁻=In⁻+POH (4)

We define an equilibrium constant Kₚ

[In⁻]/([HIn][PO⁻])=Kₚ (5)

where Kₚ will be the analog of K_{In}/K_{w} in water. Recognizing that the total indicator concentration C_{In} is given by

C_{In}=[In⁻]+[HIn] (6)

We obtain

[PO⁻]=[In⁻]/(Kₚ(C_{In}−[In⁻]) (7)

Putting eq. 7 into eq. 3 (with [POH₂⁺] neglected) results in the equality

[K⁺]−[In⁻](1+1/(Kₚ(C_{In}[In⁻]))=0 (8)

Based on the best fit of all the data in FIG. 5 and invoking a least squares minimization routine, we compute the best fit value of Kₚ for BCG in polyol to be ˜650. In water, this would correspond to an effective pK_{In} of 11.2, suggesting that the ionization of BCG is depressed by ˜7 orders of magnitude in polyol. The corresponding predicted absorbance response is plotted in the form of the solid curve of FIG. 5.

### EXAMPLE 2

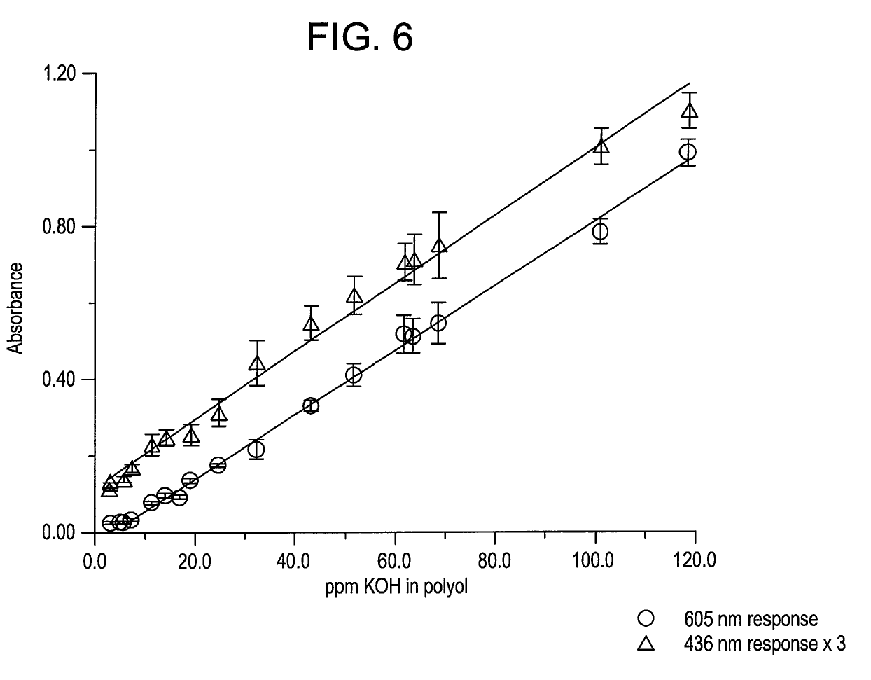

This Example will cover a higher range of base concentration. An increase in the injected indicator volume is attempted to cover the higher range. A linear range of 15-85 ppm could be obtained with an injection of 30 μL 10 mM BCG (injected at a rate of 10.4 μL/s). Since it may be desirable to extend the upper linear range to higher values, two alternatives are investigated. The first involves the injection of an indicator solution both greater in volume and concentration than those used in previous trials and the second involved the addition of a mineral acid to the indicator solution. The second alternative is found to be superior. It may be intuitive that when a mineral acid is added to the indicator reagent, the base in the polyol will first react with the mineral acid before reacting with the indicator. The response behavior of such a system is thus expected to be such that there will be a little or no response until a threshold KOH concentration is reached and then a significant linear response region will be observed before the indicator is saturated. In principle, such a system can be easily modeled assuming homogeneous conditions. However, the experimental data indicate that while a free acid and the indicator may be injected together, the effective dispersion factors of the acid and the indicator are surprisingly quite different. The proton can probably move by charge tunneling in a hydroxylic solvent like polyol, similar to what it does in water. Thus the proton will exhibit much more rapid dilution (much greater dispersion factor) than a large indicator molecule. While a quantitative model based on experimental conditions alone thus becomes more difficult to establish, the results (open circles) in FIG. 6 clearly exhibit the observed pattern. The range of KOH concentrations studied extends over the entire range possible with the polyol samples described above. In the low KOH concentration range, the 605 nm response data form essentially a horizontal line. However, the response assumes a nonzero slope at higher concentrations, and a linear r² value of 0.9949 is observed over the KOH concentration range of interest, 19-119 ppm. Attainment of a plateau is not observed. It appears likely that the linear response range at 605 nm will likely extend well beyond the maximum concentration studied here. The 436 nm detector response (shown magnified by a factor of three for clarity) that appear in FIG. 6 as triangles, are from absorption by both the blue and the yellow forms. It is not flat at the low concentrations and bears essentially a constant slope ratio with the 605 nm response at higher concentrations. In conjunction with the 605 nm response, the 436 nm response can thus be used as a diagnostic tool for proper indicator injection, etc.

### EXAMPLE 3

This Example will discuss the effect of water concentration in the polyol. The water content of chemical process polyol streams vary in different parts of the process and can range, for example, from ˜0.1% to ˜0.5%. If variation within this range can affect the overall capacity of the solvent to support protic ionization, the method of the instant invention would end up being affected severely by the water content because the effective pK of the indicator will vary. However, surprisingly the method of the instant invention is not so affected.

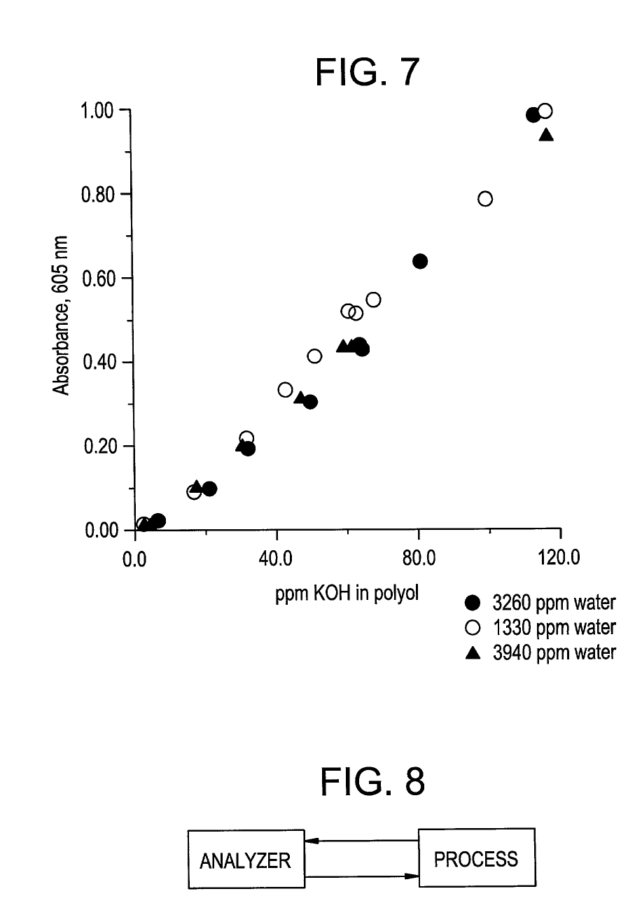

Aside from the control run with a sample containing 0.13% water, water is introduced into the flowing polyol stream with the water saturation device to the extent of 0.33% and 0.39%. The presence of increased water content is readily apparent experimentally. In the absence of any backpressure on the detector cell exit, the samples of high water content have frequent bubble problems due presumably to ebullition. The results are presented in FIG. 7 and indicate that water content variation within the limits actually encountered do not affect the reliability of the analyzer.

Summary

In summary, we have disclosed a simple and robust continuous base analyzer for polyol streams that is applicable for on-line analysis under actual process conditions in the desired ranges. The waste generated is small enough to be reintroduced into the process stream, the amount of indicator will in fact be undetectable at typical process flow rates. If indicator injection (30 μL) is conducted every 5 min, 1-L of reagent will last nearly 3 months. However, a more intelligent approach may involve setting lower and higher limits on the injection/measurement frequency and program it to increase as the measured KOH value increases (which necessitates the need for more frequent monitoring). In actual implementation, the process stream is under pressure and the desired flow rate of the analytical stream might be achieved with a mass flow controller in lieu of a pump.

Although the above discussion is made with reference to the determination of a base in a polyol, the instant invention is also applicable, of course, to the determination of an acid in a polyol using, for example, BCG in the sodium salt form as the acid-base indicator or an amine which is protonated to a differently colored acid form in the presence of an acid as the acid-base indicator.

The above discussion centers on the use of a flow injection analysis system. However, it should be understood that in its broader scope the instant invention merely requires the dispersion of an acid base indicator with the non-aqueous liquid to produce a colored product and then the determination of the intensity of the color of such dispersion. For example, a continuous stream of acid-base indicator can be mixed with a continuous stream of non-aqueous liquid to form a mixture and then the mixture can be passed through a calorimeter to determine the intensity of a color of the mixture.

What is claimed is:

1. A chemical analysis method for the determination of a base in a non-aqueous liquid, comprising the steps of:
(a) dispersing an acid-base indicator with the non-aqueous liquid to produce a colored product;
(b) determining the intensity of the color of the colored product.

2. A chemical analysis method for the determination of a base in a non-aqueous liquid, comprising the steps of:
(a) dispersing an acid-base indicator with the non-aqueous liquid to produce a concentration dispersion of the acid-base indicator in the non-aqueous liquid to produce a concentration dispersion of a colored product in the non-aqueous liquid; and
(b) determining the intensity of the color of the concentration dispersion of the colored product in the non-aqueous liquid.

3. The method of claim 2, wherein in step (b) the maximum intensity of the color of the concentration dispersion of the colored product in the non-aqueous liquid is determined.

4. The method of claim 2, wherein in step (b) the intensity of the color of the concentration dispersion of the colored product in the non-aqueous liquid is integrated across a region of the concentration dispersion of the colored product in the non-aqueous liquid.

5. The method of claim 1, wherein in step (b) the width of the intensity of the color of the concentration dispersion of the colored product in the non-aqueous liquid is determined at a preselected intensity.

6. The chemical analysis method of claim 2, wherein the base comprises an alkali metal hydroxide.

7. The chemical analysis method of claim 6, wherein the alkali metal hydroxide comprises potassium hydroxide.

8. The chemical analysis method of claim 7, wherein the acid-base indicator comprises bromocresol green in the free acid form.

9. The chemical analysis method of claim 2, wherein in step (a) the acid-base indicator is dispersed as a solution containing the acid-base indicator and a Bronsted acid.

10. The chemical analysis method of claim 7, wherein in step (a) the acid-base indicator comprises bromocresol green in the free acid form dispersed as a solution comprising 2-propanol, the bromocresol green and hydrochloric acid.

11. The chemical analysis method of claim 2, wherein the source of the nonaqueous liquid is a chemical process vessel or conduit, further comprising step (c) directing the concentration dispersion of the colored product in the non-aqueous liquid of step (b) back into a chemical process vessel or conduit.

12. The chemical analysis method of claim 11, wherein the non-aqueous liquid is a polyol.

13. The chemical analysis method of claim 11, wherein the non-aqueous liquid is a polyether polyol.

14. A chemical analysis method for the determination of an acid in a nonaqueous liquid, comprising the steps of:
(a) dispersing an acid-base indicator with the non-aqueous liquid to produce a colored product; and
(b) determining the intensity of the color of the colored product.

15. A chemical analysis method for the determination of an acid in a nonaqueous liquid, comprising the steps of:
(a) dispersing an acid-base indicator with the non-aqueous liquid to produce a concentration dispersion of the acid-base indicator in the non-aqueous liquid to produce a concentration dispersion of a colored product in the non-aqueous liquid; and
(b) determining the intensity of the color of the concentration dispersion of the colored product in the non-aqueous liquid.

16. The method of claim 15, wherein in step (b) the maximum intensity of the color of the concentration dispersion of the colored product in the non-aqueous liquid is determined.

17. The method of claim 15, wherein in step (b) the intensity of the color of the concentration dispersion of the colored product in the non-aqueous liquid is integrated across a region of the concentration dispersion of the colored product in the non-aqueous liquid.

18. The method of claim 15, wherein in step (b) the width of the intensity of the color of the concentration dispersion of the colored product in the plolyether non-aqueous liquid is determined at a preselected intensity.

19. The chemical analysis method of claim 15, wherein the acid comprises a Bronsted acid.

20. The chemical analysis method of claim 19, wherein the Bronstead acid comprises sulfuric acid.

21. The chemical analysis method of claim 20, wherein the acid base indicator comprises bromocresol green in the sodium ion form.

22. The chemical analysis method of claim 15, wherein in step (a) the acid-base indicator is dispersed as a solution containing the acid-base indicator and a Bronsted base.

23. The chemical analysis method of claim 20, wherein in step (a) the acid-base indicator is bromocresol green in the sodium ion form dispersed as a solution comprising 2-propanol, the bromocresol green and sodium hydroxide.

24. The chemical analysis method of claim 15, wherein the source of the nonaqueous liquid is a chemical process vessel or conduit, further comprising step (c) directing the concentration dispersion of the colored product in the non-aqueous liquid of step (b) back into a chemical process vessel or conduit.

25. The chemical analysis method of claim 14, wherein the non-aqueous liquid is a polyol.

26. The chemical analysis method of claim 14, wherein the non-aqueous liquid is a polyether polyol.
